(19) United States
(12) Patent Application Publication
(10) Pub. No.: US 2009/0006261 A1
(43) Pub. Date: Jan. 1, 2009

(54) PORTABLE DEVICE FOR CARRYING LICENSES

(75) Inventors: Michael S. Bernstein, Bothell, WA (US); Peter W. Cihak, Seattle, WA (US); Shawn R. LeProwse, Mercer Island, WA (US); Mitica Manu, Sammamish, WA (US); Tracy D. Schultz, Seattle, WA (US); Curt A. Steeb, Redmond, WA (US); Jeremy C. White, Kirkland, WA (US); Robert T. Whitney, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/769,958

(22) Filed: Jun. 28, 2007

(51) Int. Cl. H04L 9/00

(52) U.S. Cl. 705/59

(57) ABSTRACT

A licensing device is used for storing one or more licenses for licensable content such as music, video, e-books, software applications, online memberships, and the like. The licensing device communicates with a user's computing devices enabling licensable content to be downloaded and/or activated on a particular computing device. The communication can take many forms such as wireless, wired, or optical. Downloading and/or activation of the content upon confirmation of a valid license may be automatic or partially based on user input.

### BACKGROUND

One of the challenges in today's world where consumers own an increasing number of computing devices with varying functionality and purpose is managing software and licensable content (music, videos, etc.) on multiple devices. It is a common occurrence for a person to own a cellular phone that can play music and videos, have the same functionality on their desktop and laptop computer, even their Personal Digital Assistant (PDA). Typically, these devices are not well interconnected and do not share licenses for licensable content.

Another challenging aspect of licensable content is encountered when a user replaces one of their computing devices that may have licensable content installed. Commonly, content must be uninstalled from the old machine, the licensor notified, then reinstalled onto the new machine and go through the cumbersome relicensing process. This difficulty can be encountered for Digital Rights Management (DRM) controlled music, videos, software applications, e-books, or even membership online services (e.g. library membership).

The problematic licensing or relicensing process may be irritating to the customers and expensive (in terms of support costs) for the content providers. The content provider desires to ensure that the customer does not give the content to others without paying for it, but tying the content to a specific computer's identity is very limiting for the customer.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to providing licenses for licensable content in a licensing device that is distinct from a computing device containing the licensable content. Communicating through a variety of ways with one or more computing devices, the licensing device can enable a user to load and/or activate licensable content in those computing devices.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a conceptual diagram illustrating management of licenses for licensable content provided to a computing device;

FIG. 2 is an example networked environment, where embodiments may be implemented;

FIG. 3 is a block diagram of an example licensing device, where embodiments may be implemented;

FIG. 4 is a block diagram of an example computing device that can consume content using a licensing device according to embodiments; and

FIG. 5 illustrates a logic flow diagram of an example license management process according to embodiments.

### DETAILED DESCRIPTION

As briefly described above, a licensing device may be used to store user licenses for licensable content and to activate such content on one or more computing devices associated with the user. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

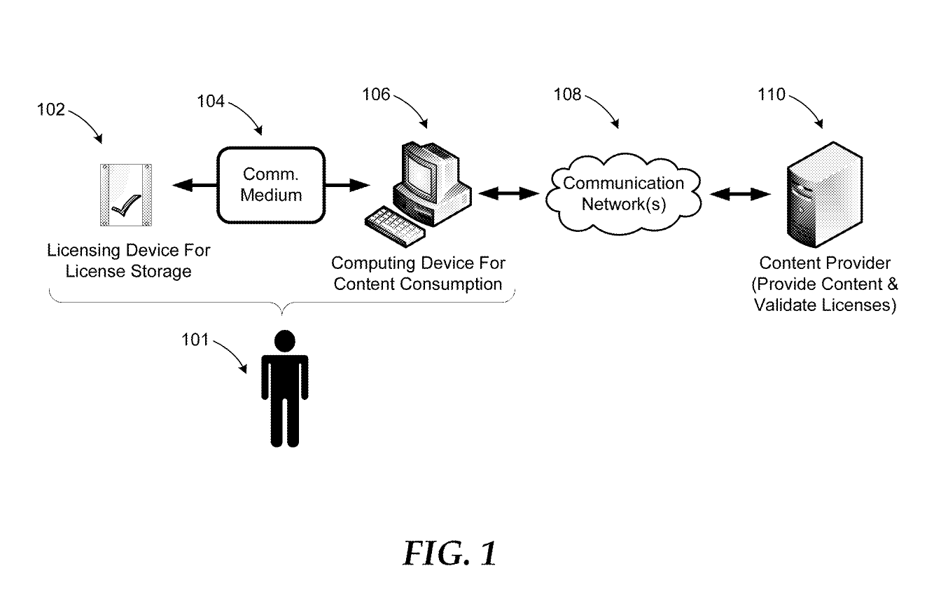

Referring to FIG. 1, a conceptual diagram illustrating management of licenses for licensable content provided to a computing device is shown. Licensable content is any form of content distributed from a content generator or licensor to a content consumer or licensee and may not be consumed without a license, which may be in form of another piece of content or a key. Licensable content may include any form of managed content such as data, video stream, audio stream, still images, software applications, electronic books (e-books), online service memberships, and the like.

Licensing device 102 is employed to store one or more licenses for licensable content consumed by a computing device (e.g. 106) associated with user 101. The licensing device 102 is also envisioned to be associated by the user 101. Licensing device 102 may be implemented in a variety of ways known in the art. According to embodiments, there are three fundamental requirements for licensing device 102: (1) store licenses; (2) communicate with the content consuming computing device while being distinct from the computing device; and (3) validate content based on the stored licenses.

For practicality purposes, licensing device 102 may be implemented as a small electronic device such as a keyfob, a USB module, a smart card, and the like. The licensing device 102 may also be an integrated part of a portable device such as a cellular phone, a portable digital player, even a remote control device. However, it should be noted, that the licensing device 102, according to embodiments, is physically separate from the computing device consuming licensable content. The physical separation does not preclude combined devices, for example a cellular phone that can play music content, where the licensing device is in form of a SIM card inserted into the cellular phone.

Computing device 106 associated with user 101 may be any computing device that consumes licensable content. Examples of licensable content have been listed previously. Hence, the computing device 106 can be a desktop computer, a laptop computer, a PDA, a cellular phone with music or video playing capability, a digital music player, a digital picture frame, and the like.

Licensing device 102 and computing device 106 may communicate over any suitable medium for validating licenses and associated content. While such media may include wired or wireless (e.g. USB connection, Ethernet connection, Wireless LAN connection), it may also include optical or other means of communication. According to one embodiment, licensing device 102 may be designed to be a small, portable device, and therefore have a limited range of communication. For example, a short range wireless transmission method similar to those used by Radio Frequency Identification (RFID) tags may be used between the licensing device and the computing device. On the other hand, licensing device 10 may also communicate through wired connections such as Universal Serial Bus (USB). According to a further embodiment, the communication may utilize optical means such as infrared beams. If the licensing device is an integral part of another device such as a cellular phone or a smart remote control device, communication means available through the host device may be used by the licensing device for communicating with the computing device consuming licensable content.

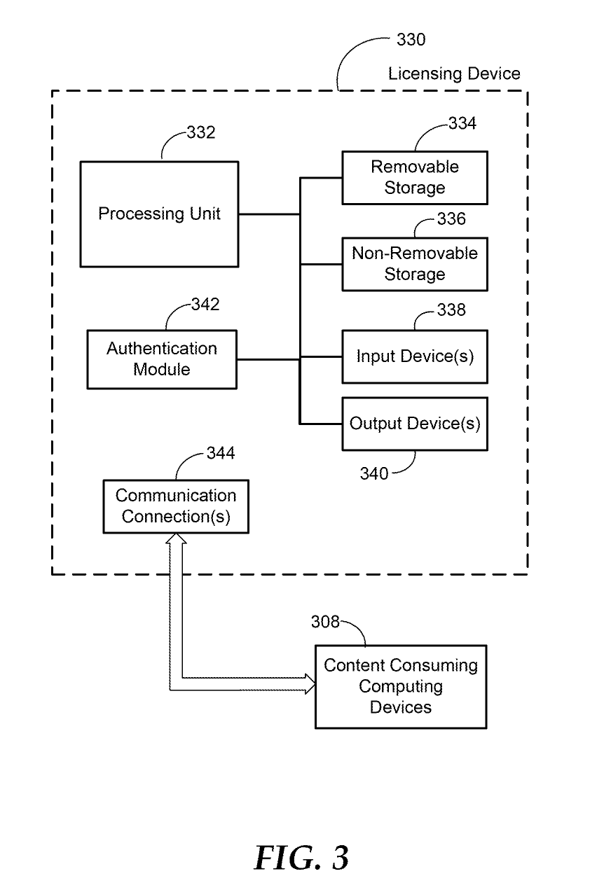

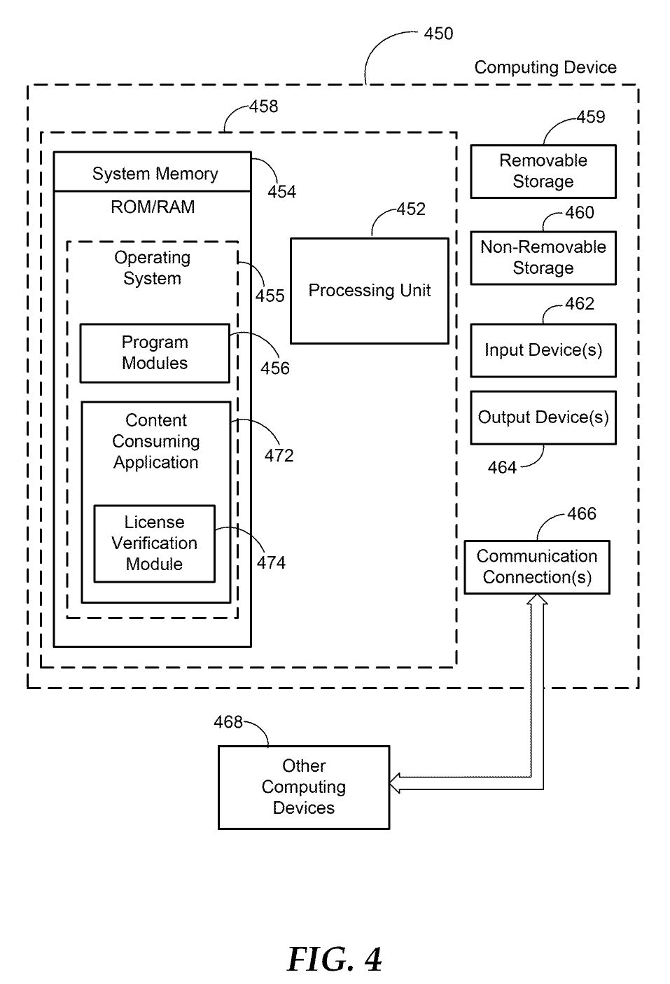

Computing device 106 may receive licensable content through one or more communication networks 108 from a content provider 110. The content may also be received through portable means such as by a compact disk, a DVD, s flash drive, and the like. Furthermore, the content may be stored (but inactive) in the computing device 106 at the time of communication with licensing device 102 or downloaded following validation of a license by the licensing device 102. Details of example operations are provided below in conjunction with FIG. 3 and FIG. 4.

Embodiments are not limited to the example implementations of licensing devices or content consuming computing devices described above. Moreover, embodiments are also not limited by the types of communication between devices or types of content. A portable device for carrying licenses may be implemented in any way using the principles described herein.

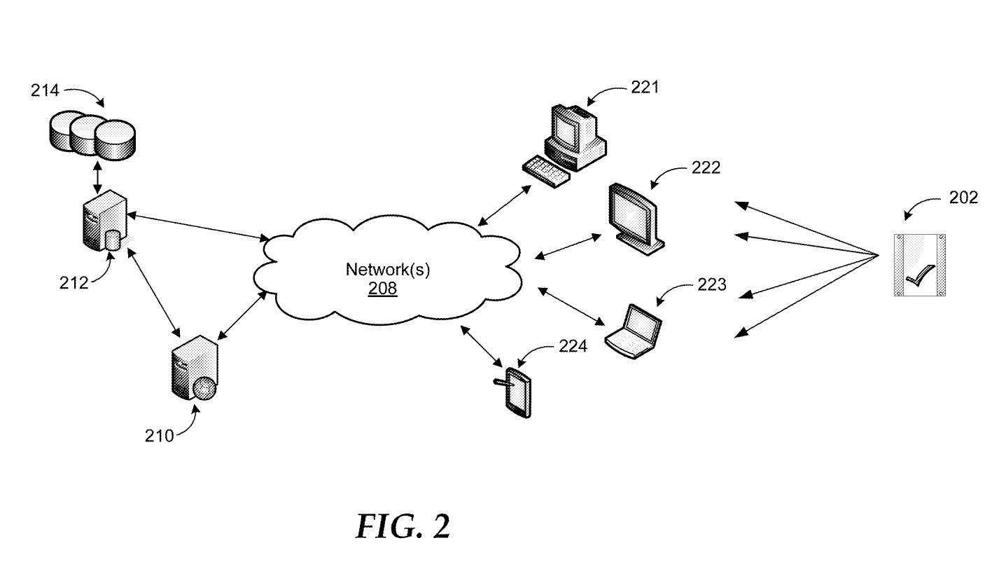

FIG. 2 is an example networked environment, where embodiments may be implemented. Licensable content distribution and consumption may be implemented locally on a single computing device or in one or more computing devices configured in a distributed manner over a number of physical and virtual clients and servers. It may also be implemented in un-clustered systems or clustered systems employing a number of nodes communicating over one or more networks (e.g. network(s) 208).

Such a system may comprise any topology of servers, clients, Internet service providers, and communication media. Also, the system may have a static or dynamic topology, where the roles of servers and clients within the system's hierarchy and their interrelations may be defined statically by an administrator or dynamically based on availability of devices, load balancing, and the like. The term “client” may refer to a client application or a client device. While a networked system implementing content distribution and consumption may involve many more components, relevant ones are discussed in conjunction with this figure.

Licensable content may be provided by content provider service 210 directly or through content storage service 212, which may include one or more data stores 214. All or part of the communications between the nodes of content provider and the consuming clients may happen over network(s) 208. Consumers of licensable content may vary as discussed previously and illustrated by client devices 221-224. Each client device may include multiple applications for consuming the same or different licensable content. In a typical scenario, however, the client devices are associated with a user or group of users assigned a license by the content provider.

In order to simplify activation of licensable content on multiple devices or applications, a user may also be associated with licensing device 202 according to some embodiments. Licensing device 202 may store obtained licenses for various content and communicate with the user's devices or applications to validate and/or activate the content. While the communication for validation and/or activation of the content may take place over a different medium than network(s) 208, embodiments are not so limited. Licensing device 202 may also utilize network(s) 208 to communicate with the client devices and/or applications associated with the user.

Moreover, a user may operate a plurality of computing devices for consumption of the same licensable content that are connected together through a different network (e.g. a laptop computer, a desktop computer, and a PDA connected through a home network). In such a scenario, the user may utilize a single licensing device for activating the content on all devices associated with him/her through his/her network.

Network(s) 208 may include a secure network such as an enterprise network, an unsecure network such as a wireless open network, or the Internet. Network(s) 208 provide communication between the nodes described herein. By way of example, and not limitation, network(s) 208 may include wired media such as a wired network or direct-wired connection, and wireless media such as acoustic, RF, infrared and other wireless media.

Many other configurations of computing devices, applications, data sources, data distribution systems may be employed to implement licensable content management through a licensing device. Furthermore, the networked environments discussed in FIG. 3 are for illustration purposes only. Embodiments are not limited to the example applications, modules, or processes.

FIG. 3, FIG. 4, and the associated discussion are intended to provide a brief general description of suitable computing environments in which embodiments may be implemented. With reference to FIG. 3, a block diagram of an example licensing device is illustrated. In a basic configuration, the licensing device 300 may be implemented as a portable standalone device or an integral part of another portable device such as a cellular phone, a PDA, a remote control device, or even a smart card. Licensing device 300 may typically include a processing unit 332. Depending on a complexity of the licensing device, it may also include a system memory such as RAM, ROM, flash memory, etc.

Licensing device 300 may also include an authentication module 342 for validating licenses and/or authenticating identities when communicating with a content consuming computing device. To store licenses and other information, licensing device 300 may include removable storage 334 and non-removable storage 336. Storage media may include volatile and nonvolatile, removable and non-removable media implemented in any method or technology for storage of information, such as computer readable instructions, data structures, program modules, or other data. Storage media includes, but is not limited to, RAM, ROM, EEPROM, flash memory or other memory technology, CD-ROM, digital versatile disks (DVD) or other optical storage. It may even include magnetic cassettes, magnetic tape, magnetic disk storage or other magnetic storage devices, or any other medium which can be used to store the desired information and which can be accessed by licensing device 300. Any such storage media may be part of licensing device 300.

Licensing device 300 may also have input device(s) 338 such as keyboard, a keypad, a touch-sensitive screen, a voice input device, touch input device, etc. The input devices may be used for a user to activate licensing device or authenticate himself/herself (e.g. password entry, biometric scanner). Licensing device 300 may further include output device(s) 340 such as a display or a speaker (e.g. for hearing-impaired). These devices are well known in the art and need not be discussed at length here.

If part of another portable device, licensing device 300 may have additional features or functionality and includes communication connections 344 that allow the device to communicate with other computing devices 308, such as over a wireless network in a distributed computing environment, for example. Other computing devices 308 may include any device for licensable content consumption. According to one embodiment, other computing devices may also include a server of the content provider to loading the license(s) to the licensing device 300.

Communication connection 344 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

According to one embodiment, a content activation operation may take place as follows: The licensing device may initiate communication with a suitably configured computing device over a wireless link, or a physical connection. If the licensing device is not required to be physically connected to the computing device, appropriate protection mechanisms may be implemented to prevent others from activating their content without permission. Once communication is established, the computing device and the licensing device may authenticate each other's identities. This may be performed through any one of the well known methods of authentication. The authentication is particularly important in case of portable devices, which may be lost or stolen more easily than stationary devices.

Next, the licensing device may notify the computing device of the available licenses. The licenses may be associated with already downloaded, but locked content (music, video, software application, membership, etc.) or with content that is to be downloaded once the license is validated. The user may then select a license through the computing device or the licensing device itself. Following the selection, the content may be validated against the license. This may range from a simple comparison of a license number to validation with the content provider over a network.

Following the validation, the user may gain access to the already downloaded content or the computing device may be enabled to download and activate the content associated with the license. According to another embodiment, the license may be based on number of uses or duration of use. In such cases, the licensing device may be configured to record the usage parameters such that it can determine when the license expires and stop activating the content upon expiration of the license. For example, a license associated with a music file may be for 20 sessions of playback. The license device may allow the music file to be played once for each activation and not allow further activation after the 20^{th} time.

According to a further embodiment, the content may be locked after a predefined amount of use (based on time, number of uses) or if the licensing device is no longer connected to the computing device. The computing device may also be instructed to delete data associated with the content after use according to activation terms.

FIG. 4 is a block diagram of an example computing device that can consume content using a licensing device according to embodiments. In a basic configuration, the computing device 450 may be a server or a client machine. Computing device 450 may typically include at least one processing unit 452 and system memory 454. Computing device 450 may also include a plurality of processing units that cooperate in executing programs. Depending on the exact configuration and type of computing device, the system memory 454 may be volatile (such as RAM), non-volatile (such as ROM, flash memory, etc.) or some combination of the two. System memory 454 typically includes an operating system 455 suitable for controlling the operation of a networked personal computer, such as the WINDOWS® operating systems from MICROSOFT CORPORATION of Redmond, Wash. The system memory 454 may also include one or more software applications such as program modules 456, content consumption application 472 and license verification module 474.

Content consumption application 472 may be an application or part of a managed service and associated with additional modules than the ones illustrated for additional functionality associated with consuming licensable content provided by a third party. Functionality and operations of content consumption application 472 and license verification module 474 have been described previously. This basic configuration is illustrated in FIG. 4 by those components within dashed line 458.

The computing device 450 may have additional features or functionality. For example, the computing device 450 may also include additional data storage devices (removable and/or non-removable) such as, for example, magnetic disks, optical disks, or tape. Such additional storage is illustrated in FIG. 4 by removable storage 459 and non-removable storage 460. Computer storage media may include volatile and nonvolatile, removable and non-removable media implemented in any method or technology for storage of information, such as computer readable instructions, data structures, program modules, or other data. System memory 454, removable storage 459, and non-removable storage 460 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 450. Any such computer storage media may be part of device 450. Computing device 450 may also have input device(s) 462 such as keyboard, mouse, pen, voice input device, touch input device, etc. Output device(s) 464 such as a display, speakers, printer, etc. may also be included. These devices are well known in the art and need not be discussed at length here.

The computing device 450 may also contain communication connections 466 that allow the device to communicate with other computing devices 468, such as over a wireless network in a distributed computing environment, for example, an intranet or the Internet. Other computing devices 468 may include server(s) of the content provider for downloading licensable content. Communication connection 466 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

While a typical computing device is described here as an example of content consuming device, other types of devices such as digital music players, digital video players, digital picture frames, handheld devices, and the like may also be used in conjunction with a licensing device according to embodiments.

The claimed subject matter also includes methods of operation. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

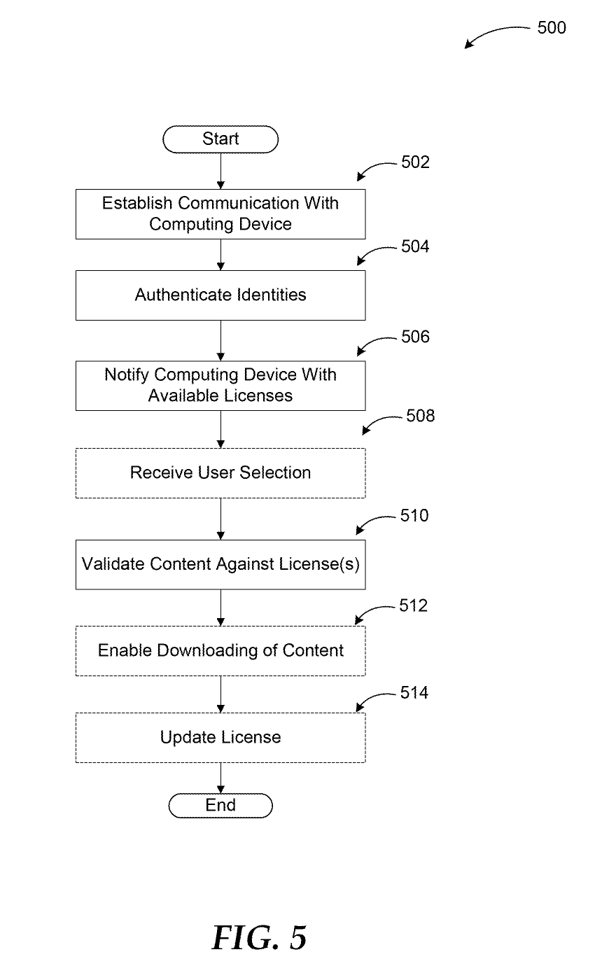

FIG. 5 illustrates a logic flow diagram of an example license management process according to embodiments. Process 500 may be implemented in a licensing device such as licensing device 300 of FIG. 3.

Process 500 begins with operation 502, where communication is established between the licensing device and a content consuming computing device as described previously. Processing advances from operation 502 to operation 504. At operation 504, the computing device and the licensing device authenticate each other's identities to prevent unauthorized use of the license(s). Processing continues to operation 506 from operation 504.

At operation 506, the computing device is notified of the available licenses in the licensing device. Processing moves to optional operation 508 from operation 506. At optional operation 508, the licensing device receives a user selection of one or more licenses. Processing advances from optional operation 508 to operation 510, where the content is validated against the selected license(s). Processing then moves to optional operation 512.

At optional operation 512, the user is enabled to download the content from the content provider. According to embodiments, content may be downloaded (but locked) prior to validation of the license, downloaded by the user upon validation of the license, or downloaded and activated automatically upon validation of the license. Processing continues from optional operation 512 to optional operation 514, where the license may be updated (e.g. use-based or with user information). After optional operation 514, processing moves to a calling process for further actions.

The operations included in process 500 are for illustration purposes. Providing licensable content using a portable licensing device may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for managing storage of licenses for licensable content, the method comprising:
storing a license associated with a user in a licensing device distinct from a device for consuming licensable content associated with the license;
establishing communication with the device for consuming the content, wherein the communication includes at least one of:
notifying the device for consuming the content about the available license; and
receiving a query from the device for consuming the content for available licenses;
validating the content against the license; and
enabling consumption of the content at the device for consuming the content.

2. The method of claim 1, further comprising:
authenticating an identity of the device for consuming the content.

3. The method of claim 1, further comprising:
authenticating an identity of the licensing device to the device for consuming the content.

4. The method of claim 1, wherein a plurality of licenses are stored at the licensing device, and wherein the method further comprises:
receiving a user selection of at least one license; and
validating the contents against the selected licenses.

5. The method of claim 1, further comprising:
enabling the device for consuming the content to download the content from a content provider upon validating the content against the license.

6. The method of claim 1, wherein the content is preloaded to the device for consuming the content in an inactive status, and wherein the content is activated upon validating the content against the license.

7. The method of claim 1, wherein the content is associated with a plurality of devices connected through a network, and wherein each device is enabled to consume the content upon validating the content against the license by one device.

8. The method of claim 1, wherein the licensing device is configured to communicate with the device for consuming the content through at least one from a set of: a wireless communication medium, a wired communication medium, and an optical communication medium.

9. The method of claim 1, wherein the content includes at least one from a set of: an audio stream, a video stream, a still image, a data file, an electronic book, a software application, a software application consumable, and an online service membership.

10. The method of claim 1, wherein the license is based on usage of the content, and the method further includes:
recording the usage of the content at the licensing device; and
updating the license based on the recorded usage.

11. The method of claim 10, wherein the usage includes one of: a number of consumption of the content and a duration of consumption of the content.

12. A licensing device for managing storage of licenses for licensable content, the system comprising:
a memory for storing at least one license associated with content to be consumed by a computing device distinct from the licensing device;
a communication module for communicating with the computing device;
a processing unit for validating content at the computing device against the at least one license, and enabling the computing device to consume the content upon validating the content.

13. The licensing device of claim 12, wherein the processing unit is further configured to:
provide the computing device a list of available licenses at the licensing device;
receive a user selection of licenses; and
validate content associated with the selected licenses such that content associated with the selected licenses is enabled to be consumed by the computing device.

14. The licensing device of claim 13, further comprising at least one from a set of:
an authentication module for authenticating the computing device;
an input device for receiving at least one of: a user authentication and the user selection of licenses; and
a display for providing feedback to the user.

15. The licensing device of claim 12, wherein the licensing device is an integral part of a portable electronic device distinct from the computing device.

16. The licensing device of claim 15, wherein the communication module is further configured to utilize a communication medium available in the portable electronic device for communicating with the computing device.

17. The licensing device of claim 12, wherein the communication module is further configured to receive updated licenses from a content provider.

18. A computer-readable storage medium with instructions encoded thereon for managing storage of licenses for licensable content, the instructions comprising:
storing a plurality of licenses associated with a user in a licensing device distinct from a computing device for consuming licensable content associated with at least one of the licenses;
establishing communication with the computing device;
authenticating an identity of the computing device;
providing the computing device a list of available licenses;
receiving at least one of: a user selection of desired licenses and a list of existing content at the computing device;
validating received information against the available licenses;
enabling consumption of the content at the computing device for consumption.

19. The computer-readable storage medium of claim 18, wherein the instructions further comprise:
recording a usage of the content at the licensing device, wherein the usage includes one of: a number of consumption of the content and a duration of consumption of the content; and
updating the license based on the recorded usage for future validation.

20. The computer-readable storage medium of claim 18, wherein the computing device includes at least one from a set of: a desktop computer, a laptop computer, a Personal Digital Assistant (PDA), a smart phone, a digital music player, a digital video player, a digital picture frame, and an electronic book reader.
